(19) United States
(12) Patent Application Publication
(10) Pub. No.: US 2016/0038888 A1
(43) Pub. Date: Feb. 11, 2016

(54) ION EXCHANGE MEMBRANES SELECTIVELY PERMEABLE TO SPECIFIC IONS

(71) Applicant: SALTWORKS TECHNOLOGIES INC., Vancouver (CA)

(72) Inventors: Xiangchun Yin, Vancouver (CA); Zhongyuan Zhou, Vancouver (CA)

(73) Assignee: Saltworks Technologies Inc., Vancouver, BC (CA)

(21) Appl. No.: 14/782,769

(22) PCT Filed: Mar. 25, 2014
(86) PCT No.: PCT/CA2014/050309

§ 371 Date: Oct. 6, 2015

Related U.S. Application Data
(60) Provisional application No. 61/809,680, filed on Apr. 8, 2013.

(51) Int. Cl. B01D 71/76; B01D 69/12; C08J 5/22; B01D 61/44; B29C 39/12; B29C 37/00; B01D 71/58; B01D 67/00

(52) U.S. Cl. CPC B01D 71/76; B01D 71/58; B01D 69/12; B01D 67/0006; B01D 61/44; B29C 39/123; B29C 37/0025; C08J 5/2231; B01D 2323/30; B29K 2023/04; B29K 2995/0037; B29L 2009/005

(57) ABSTRACT

A monovalent ion permselective ion exchange membrane comprising a base layer consisting of an ion exchange membrane, and a monovalent ion permselective layer affixed to the surface of the base layer. The monovalent ion permselective layer is formed by coating and polymerizing a polymerizable solution onto the base ion exchange membrane layer. The polymerizable solution comprises: (i) of an ionic monomer having one or more ethylenic groups selected from (meth)acryloxy groups, (meth)acryl-amido groups, and vinylbenzyl groups, (ii) a hydrophobic crosslinking monomer having two or more ethylenic groups selected from (meth)acryloxy groups, (meth)acrylamido groups, and vinylbenzyl groups, (iii) a free radical initiator, in (iv) a solvent medium. The monovalent ion permselective ion exchange membranes include monovalent cation permselective ion exchange membranes and monovalent anion permselective ion exchange membranes. Also disclosed are processes for preparing the monovalent ion permselective ion exchange membranes.

### TECHNICAL FIELD

This disclosure relates to permselective ion exchange membranes. More particularly, this disclosure relates to permselective ion exchange membranes that are substantially more permeable to monovalent ions in comparison to their permeability to multivalent ions. This disclosure also relates to processes for preparing monovalent ion permselective ion exchange membranes.

### BACKGROUND

Ion exchange membranes are used in electrodialysis, electrolysis, and diffusion dialysis wherein the transport of ions occurs under the influence of a driving force such as an ion concentration gradient or alternatively, an electrical potential gradient. Based on the fixed ion exchange groups on their membrane matrices, ion exchange membranes are categorized into cation exchange membranes and anion exchange membranes. Cation exchange membranes contain negatively charged groups fixed to the matrix and allow the passage of cations but reject anions, while anion exchange membranes contain positively charged groups fixed to the matrix and allow the passage of anions but reject cations. After their developments for more than seventy years, ion exchange membranes have attained almost an ideal level in the separation between cations and anions at any concentration of salt solutions. However, in some applications, specific ions need be concentrated or removed from a solution containing a mixture of salts. In such applications, ion exchange membranes must be able to separate a specific ion from various other types of ions with the same charge signs or even with same valences. Ion exchange membranes selectively permeable to specific ions such as monovalent ions versus multivalent ions have been used industrially. For example, Astom Corp. produces monovalent anion permselective ion exchange membranes (NEOSEPTA® ACS; NEOSEPTA is a registered trademark of the Tokuyama Corp., Tokuyama City, JP) and monovalent cation permselective ion exchange membranes (NEOSEPTA® CMS). Monovalent ion permselective ion exchange membranes have been used for many years to produce 18 wt % to 20 wt % salt brine from sea water for the purpose of producing edible sodium chloride.

Various methods of preparing ion exchange membranes that are selectively permeable to monovalent ions are known in the art. While they can solve some problems related to ion permeability, they also add other problems.

U.S. Pat. No. 3,847,772 discloses a method for selectively electrodialyzing monovalent cations from an aqueous electrolytic solution containing two or more classes of cations of differing valences, using a monvalent cation permselective ion exchange membrane in which a polyelectrolyte exemplified by polyethyleneimine, has been uniformly adsorbed onto the surface of the membrane. U.S. Pat. No. 6,569,301 discloses a cation exchange membrane that is selectively permeable to monovalent cations wherein the cationic polyelectrolytes in the presence of oxyacid anions or organic sulfonic acid anions. However, the permselectivity of such membranes to monovalent cations gradually deteriorates over time because the physically adsorbed polyelectrolytes are washed off from such membrane surfaces during electrodialysis processes.

U.S. Pat. Appl. No.2012/0312688 discloses monovalent cation permselective ion exchange membranes that are modified at their surfaces by covalent grafting of polyaniline-type polymers. However, those skilled in these arts understand that it is very hard to control the covalent grafting reactions to occur only at the membrane surfaces and therefore, such membranes do not have consistent coating thicknesses of the polymers across their surfaces.

U.S. Pat. No. 4,923,611 discloses monovalent anion permselective ion exchange membranes produced by irradiating with ultraviolet light, membranes comprising a high-molecular-weight compound having haloalkyl groups to decrease the proportion of haloalkyl groups present at their surfaces, after which, the haloalkyl groups are converted into anion-exchange groups. However, such methods are expensive and not practical for production of commercial-scale quantities of the permselective ion exchange membranes.

EP 0,315,510 discloses permselective laminated monovalent ion exchange membranes formed from: (i) one or more hydrophobic film-forming polymers comprising covalently-attached ionizable radicals, and (ii) a polymer derived from monomers comprising amino groups for reducing the electrical resistance per micron thickness of film. However, such membranes are unstable and often delaminate during use in electrodialysis processes.

### SUMMARY

The embodiments of the present disclosure pertain to monovalent ion permselective ion exchange membranes for separating selected monovalent ions from a mixture of monovalent ions and multivalent ions.

Some exemplary embodiments of the present disclosure pertain to monovalent cation permselective ion exchange membranes for separating one or more monovalent cations from a mixture of monovalent ions and multivalent ions.

Some exemplary embodiments of the present disclosure pertain to monovalent anion permselective ion exchange membranes for separating one or more monovalent anions from a mixture of monovalent ions and multivalent ions.

Some exemplary embodiments of the present disclosure pertain to processes for preparing the monovalent cation permselective ion exchange membranes disclosed herein.

Some exemplary embodiments of the present disclosure pertain to processes for preparing the monovalent anion permselective ion exchange membranes disclosed herein.

### DETAILED DESCRIPTION

The exemplary embodiments of the present disclosure pertain to ion exchange membranes substantially permeable to monovalent ions in comparison to their permeability to multivalent ions.

Those skilled in this art will understand that permselectivity among ionic components in a mixture through non-porous separation membranes is governed by: (i) the differences in the affinities of the ionic components with a non-porous separation membrane, and (ii) the differences in the migration speeds of the individual ionic components through the non-porous separation membrane. For example, permselectivity among cations through cation-exchange membranes in electrodialysis processes, is governed by the affinity of the cations with the membranes (i.e., the ion-exchange equilibrium constant) and the differences in the migration speeds of the individual cations through the membrane phase (i.e., the mobility ratios among the cations). To simplify the system, a standard cation is selected as the reference cation (sodium ions are generally used as the reference cation) and the ratio of the permeated equivalent of a selected cation to that of the reference cation is examined. Namely, permselectivity of a given cation is evaluated by the permeated equivalent of the cation when one equivalent of sodium ions permeates through the membrane.

An exemplary monovalent ion permselective ion exchange membrane according to one embodiment of the present disclosure may be produced by coating one or both surfaces of an ion exchange membrane with a polymerizable solution comprising: (i) an ionic monomer having one or more ethylenic groups selected from (meth)acryloxy groups, (meth)acrylamido groups, and vinylbenzyl groups, (ii) a hydrophobic crosslinking monomer having two or more ethylenic groups selected from (meth)acryloxy groups, (meth)acrylamido groups, and vinylbenzyl groups, (iii) a free radical initiator, in (iv) a solvent medium. After the solution is coated onto the surface of the ion exchange membrane, it is then polymerized to form a monovalent ion permselective layer on the surface of the ion exchange membrane. The resulting monovalent ion permselective layer is permanently affixed to the surface of the base ion exchange membrane through a method exemplified by covalent bonding through the copolymerization between ethylenic groups in the base membrane and ethylenic groups of monomers in the surface coating solution. Alternatively, the monovalent ion permselective layer may be permanently affixed to the surface of the base ion exchange membrane by interpenetration of polymer chains from the permselective layer with polymer chains from the superficial layer of the base ion exchange membrane. Alternatively, the monovalent ion permselective layer may be permanently affixed to the surface of the ion exchange membrane by mechanical interlocking of polymer chains from the permselective layer within micro-surface sites characterized by the microroughness of the ion exchange membranes. The term “microroughness” as used herein means the texture or the microtopography of a surface.

An exemplary embodiment of the present disclosure pertains to methods for preparing monovalent permselective ion exchange membranes. An exemplary method comprises the steps of:
1. preparing a polymerizable solution comprising a mixture of: (i) an ionic monomer having one or more ethylenic groups selected from (meth)acryloxy groups, (meth)acrylamido groups, and vinylbenzyl groups, (ii) a hydrophobic crosslinking monomer having two or more ethylenic groups selected from (meth)acryloxy groups, (meth)acrylamido groups, and vinylbenzyl groups, (iii) a free radical initiator, in (iv) a solvent medium,
2. coating the solution onto one or both surfaces of a base ion exchange membrane,
3. polymerizing the solution to form a monovalent ion permselective layer affixed to the surface of the ion exchange membrane.

The term “monovalent permselective ion exchange membrane” as used herein means an ion exchange membrane substantially permeable to one or more selected monovalent ions in comparison to its permeability to multivalent ions, comprising a base ion exchange membrane onto which has been affixed a monovalent ion permselective layer.

The term “substantially permeable” as used herein means a permeability ratio of monovalent ions to multivalent ions being greater than 1:1 and preferably greater than 3:1.

The hydrophobicity of the exemplary monovalent ion permselective layer may be optimized by mixing a hydrophobic ionic monomer into the polymerizable solution prior to coating the solution onto the base ion exchange membrane. Alternatively, the hydrophobicity of the exemplary monovalent ion permselective layer may be optimized by mixing a hydrophilic ionic monomer and a hydrophobic monomer into the polymerizable solution prior to coating the solution onto the base ion exchange membrane. Alternatively, the hydrophobicity of the exemplary monovalent ion permselective layer may be optimized by mixing a hydrophobic crosslinking monomer into the polymerizable solution prior to coating it onto the base ion exchange membrane.

The crosslinking density of the monovalent ion permselective layer of the monovalent ion permselective ion exchange membranes disclosed herein, may be modulated (i.e., made to be higher or lower) by adjusting the weight ratio of the crosslinking monomer to relative to the weight ratio of the ionic monomer in the polymerizable solution. The thickness of permselective layer of the monovalent ion permselective ion exchange membranes disclosed herein, may be modulated (i.e., made to be thicker or thinner) to modulate the electrical resistance of the monovalent ion permselective ion exchange membranes produced by the exemplary methods of the present disclosure.

According to one exemplary embodiment, a suitable ionic monomer for preparation of the polymerizable solution used for producing a monovalent ion permselective layer affixed to one or both surfaces of a base ion exchange membrane, may be a hydrophilic anionic monomer exemplified by sodium 4-vinylbenzenesulfonate, 3-sulfopropyl acrylate potassium salt, and 2-acrylamido-2-methyl-1-propanesulfonic acid, and the like.

According to another exemplary embodiment, a suitable ionic monomer for preparation of the polymerizable solution used for producing a monovalent ion permselective layer affixed to one or both surfaces of a base ion exchange membrane may be a hydrophobic anionic monomer having the structure shown in Formula 1:

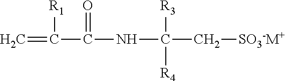

wherein R₁ is hydrogen or a methyl group, R₃ is hydrogen or a C₁-C₃ alkyl group, R₄ is a hydrophobic group having a long alkyl group comprising 4-22 carbon atoms, and M⁺ is a H⁺ ion or a salt ion. Such suitable hydrophobic anionic monomer monomers may be synthesized by following the methods taught in U.S. Pat. No. 3,506,707.

According to another exemplary embodiment, a suitable ionic monomer for preparation of the polymerizable solution used for producing a monovalent ion permselective layer affixed to one or both surfaces of a base ion exchange membrane may be an anionic monomer with two or more ethylenic groups selected from (meth)acryloxy groups, (meth)acrylamido groups, and vinylbenzyl groups. Such suitable anionic monomers having two or more ethylenic groups may be synthesized by following the methods taught in U.S. Pat. No. 4,034,001.

According to another exemplary embodiment, a suitable ionic monomer for preparation of the polymerizable solution used for producing a monovalent ion permselective layer affixed to one or both surfaces of a base ion exchange membrane, may be a hydrophilic cationic monomer exemplified by 3-acrylamidopropyl trimethylammonium chloride, 2-acryloyloxyethyl trimethylammonium chloride, 2-methacryloyloxyethyl trimethylammonium chloride, 3-methacryloylaminopropyl trimethylammonium chloride, vinylbenzyl trimethylammonium chloride, and the like.

According to another exemplary embodiment, a suitable ionic monomer for preparation of the polymerizable solution used for producing a monovalent ion permselective layer affixed to one or both surfaces of a base ion exchange membrane may be a hydrophobic cationic monomer having the structure shown in Formula 2:

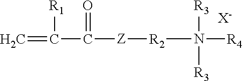

wherein R₁ is hydrogen or a methyl group, Z is —O⁻ or —NH⁻, R₂ and R₃ are C₁-C₄ alkyl groups, R₄ is a hydrophobic group having a long alkyl group comprising 6-22 carbon atoms, and X⁻is Cl⁻, Br⁻, I⁻, or acetate. Such suitable hydrophobic cationic monomers may be synthesized by following the methods taught in U.S. Pat. Nos. 4,212,820 and 4,918,228. Alternatively, such suitable hydrophobic cationic monomers may be synthesized by following the method taught by Chang et al. (1993, Water-soluble copolymers. 49. Effect of the distribution of the hydrophobic cationic monomer dimethyldodecyl(2-acrylamidoethyl)ammonium bromide on the solution behavior of associating acrylamide copolymers. Macromolecules 26(22):6121-6126).

According to another exemplary embodiment, a suitable ionic monomer for preparation of the polymerizable solution used for producing a monovalent ion permselective layer affixed to one or both surfaces of a base ion exchange membrane, may be a cationic monomer having two or more polymerizable ethylenic groups selected from (meth)acryloxy groups, (meth)acrylamido groups, and vinylbenzyl groups. Such suitable cationic monomers may be synthesized by following the methods taught in U.S. Pat. Nos. 5,118,717 and 7,968,663.

According to another exemplary embodiment, suitable hydrophobic cross-linking monomers for preparation of the polymerizable solution used for producing a monovalent ion permselective layer affixed to one or both surfaces of a base ion exchange membrane, may be hydrophobic monomers having two or more ethylenic groups selected from (meth)acryloxy groups, (meth)acrylamido groups, and vinylbenzyl groups. Such crosslinking monomers are exemplified by bisphenol A dimethacrylate, hexanediol diacrylate, decanediol diacrylate, hexyl diacrylamide, 4,4′-methylene bis(phenyl acrylamide), 4,4′-methylene bis(cyclohexyl acrylamide), isophorone diacrylamide, trimethyl hexamethylene diacrylamide, polyurethane oligomer diacrylate, polyester oligomer diacrylate, polyether oligomer diacrylate, epoxy oligomer diacrylate, and polybutadiene oligomer diacrylate.

According to another exemplary embodiment, suitable free radical initiators for preparation of the polymerizable solution used for producing a monovalent ion permselective layer affixed to one or both surfaces of a base ion exchange membrane, are exemplified by photoinitiators that release free radicals upon exposure to UV light such as α-hydroxy ketones, benzoin ethers, benzil ketals, α-dialkoxy acetophenones, α-hydroxy alkylphenones, α-amino alkylphenones, acylphophine oxides, benzophenons/amines, thioxanthone/amines, titanocenes, and mixtures thereof. Alternatively, also suitable are α-hydroxy ketone free radical initiators exemplified by 2-hydroxy-1-[4-(2-hydroxyethoxy)phenyl]-2-methyl-1-propanone, 2-hydroxy-2-methyl-1-phenyl-1-propanone, 1-hydroxy-cyclohexyl-phenyl-ketone, 1-hydroxy-cyclohexyl-phenyl-ketone:benzophenone, and mixtures thereof.

According to another exemplary embodiment, suitable solvents for preparation of the polymerizable solution used for producing a monovalent ion permselective layer affixed to one or both surfaces of a base ion exchange membrane, are exemplified by diethylene glycol, diethylene glycol methyl ether, 1,3-butanediol, ethanol, isopropanol, 1-butanol, N-methyl-2-pyrrolidone, dimethylacetamide, water, and mixtures thereof.

The polymerizable solution may be coated directly onto one or both surfaces of a base ion exchange membrane using coating methods exemplified by casting, dip-coating, spraying coating and slot die coating. It should be noted that the polymerizable solution should be applied to provide a permselective layer having a thickness (i) in the range of about 0.1 μm to about 50 μm, and (ii) about 1% to about 50% of the thickness of the base ion exchange membrane, to avoid the final monovalent ion permselective ion exchange membranes having much-increased electric resistance properties. It was unexpectedly discovered that when the thicknesses of a monovalent ion permselective layer affixed to the base ion exchange membranes are less than 20% of the total thickness of the final membranes, there is no increase or alternatively, a very small increase in the electric resistance properties monovalent ion permselective ion exchange membranes of the present disclosure, when compared to the electric resistance of the base ion exchange membrane.

The monovalent ion permselective layers of the monovalent ion permselective ion exchange membranes produced by the exemplary methods of the present disclosure have a very high degree of adhesion to the underlying base ion exchange membranes because of (i) the intimate contact of the coating solution with the base ion exchange membrane and (ii) the in-situ curing step to affix the permselective layer to the base ion exchange membrane.

Another exemplary embodiment of the present disclosure pertains to an alternative method for preparing monovalent ion permselective ion exchange membranes that are substantially more permeable to monovalent ions in comparison to their permeability to multivalent ions. An exemplary method comprises forming the permselective layer concurrently with preparation of the base ion exchange membrane. A formulated solution for the base ion exchange membrane is cast as a first coating after which a polymerizable coating solution for the permselective layer is subsequently coated on top of the newly formed base ion exchange membrane coating. Both coatings are then cured together to form the exemplary monovalent ion permselective ion exchange membranes of the present disclosure. The advantage of this procedure is that it eliminates some processes of handling the base ion exchange membrane, and can result in affixing the permselective layer more permanently to the surface of the base membrane.

The methods disclosed herein can be used to prepare, for example, a monovalent cation permselective ion exchange membrane wherein one or both surfaces of a selected base cation exchange membrane is coated with a polymerizable solution comprising (i) an ionic monomer having one or more ethylenic groups exemplified by (meth)acryloxy groups, (meth)acrylamido groups, and vinylbenzyl groups, (ii) a hydrophobic crosslinking monomer having two or more ethylenic groups exemplified by (meth)acryloxy groups, (meth)acrylamido groups, and vinylbenzyl groups, (iii) a free radical initiator, in (iv) a selected solvent medium. The solution is polymerized to form a monovalent cation permselective layer affixed to one or both surfaces of the base cation exchange membrane. Suitable base cation exchange membranes are exemplified by NEOSEPTA® CMX membranes that may be sourced from Astom Corp. (Tokyo, Japan). Alternatively, suitable base cation exchange membranes may be prepared as illustrated in the Examples provided with this disclosure.

According to another exemplary embodiment, a suitable ionic monomer for preparation of a polymerizable solution for producing a monovalent cation permselective layer affixed to one or both surfaces of a base cation exchange membrane, is exemplified by sodium 4-vinylbenzenesulfonate, 3-sulfopropyl acrylate potassium salt, and 2-acrylamido-2-methyl-1-propanesulfonic acid, and the like.

According to another exemplary embodiment, a suitable ionic monomer for preparation of a polymerizable solution for producing a monovalent cation permselective layer affixed to one or both surfaces of a base cation exchange membrane, may be the hydrophobic anionic monomer having the structure shown in Formula 1.

According to another exemplary embodiment, a suitable ionic monomer for preparation of the polymerizable solution used for producing a monovalent cation permselective layer affixed to one or both surfaces of a base cation exchange membrane, may be an anionic monomer having two or more ethylenic groups exemplified by (meth)acryloxy groups, (meth)acrylamido groups, and vinylbenzyl groups. Such suitable anionic monomers with two or more ethylenic groups may be synthesized by following the method taught in U.S. Pat. No. 4,034,001.

According to another exemplary embodiment, a suitable ionic monomer for preparation of the polymerizable solution for producing a monovalent cation permselective layer affixed to one or both surfaces of a base cation exchange membrane, is exemplified by hydrophilic cationic monomers such as 3-acrylamidopropyl trimethylammonium chloride, 2-acryloyloxyethyl trimethylammonium chloride, 2-methacryloyloxyethyl trimethylammonium chloride, 3-methacryloylaminopropyl trimethylammonium chloride, vinylbenzyl trimethylammonium chloride, and their mixtures.

According to another exemplary embodiment, a suitable ionic monomer for preparation of a polymerizable solution for producing a monovalent cation permselective layer affixed to one or both surfaces of a base cation exchange membrane, may be a hydrophobic cationic monomer shown in Formula 2.

According to another exemplary embodiment, a suitable ionic monomer for preparation of a polymerizable solution for producing a monovalent permselective layer affixed to one or both surfaces of a base cation exchange membrane, is exemplified by cationic monomers having two or more polymerizable ethylenic groups selected from (meth)acryloxy groups, (meth)acrylamido groups, and vinylbenzyl groups. Such suitable cationic monomers may be synthesized by following the methods taught in U.S. Pat. Nos. 5,118,717 and 7,968,663.

According to another exemplary embodiment, a suitable ionic monomer for preparation of the polymerizable solution used for producing a monovalent cation permselective layer affixed to one or both surfaces of a base cation exchange membrane, may be a mixture of an anionic monomer and a cationic monomer having a molar ratio from about 0.05:1 to about 0.95:1. Suitable anionic monomers are exemplified by anionic monomers with one or more ethylenic groups selected from (meth)acryloxy groups, (meth)acrylamido groups, and vinylbenzyl groups. Suitable cationic monomers are exemplified by cationic monomers with one or more ethylenic groups selected from (meth)acryloxy groups, (meth)acrylamido groups, and vinylbenzyl groups.

According to another exemplary embodiment, suitable hydrophobic cross-linking monomers for preparation of the polymerizable solution used for producing a monovalent cation permselective layer affixed to one or both surfaces of a base cation exchange membrane, may be hydrophobic crosslinking monomers having two or more ethylenic groups selected from (meth)acryloxy groups, (meth)acrylamido groups, and vinylbenzyl groups. Such crosslinking monomers are exemplified by bisphenol A dimethacrylate, hexanediol diacrylate, decanediol diacrylate, hexyl diacrylamide, 4,4′-methylene bis(phenyl acrylamide), 4,4′-methylene bis(cyclohexyl acrylamide), isophorone diacrylamide, trimethyl hexamethylene diacrylamide, polyurethane oligomer diacrylate, polyester oligomer diacrylate, polyether oligomer diacrylate, epoxy oligomer diacrylate, and polybutadiene oligomer diacrylate.

According to another exemplary embodiment, suitable free radical initiators for preparation of the polymerizable solution used for producing a monovalent cation permselective layer affixed to one or both surfaces of a cation exchange membrane, are exemplified by photoinitiators that release free radicals upon exposure to UV light such as α-hydroxy ketones, benzoin ethers, benzil ketals, α-dialkoxy acetophenones, α-hydroxy alkylphenones, α-amino alkylphenones, acylphophine oxides, benzophenons/amines, thioxanthone/amines, and titanocenes. Alternatively, also suitable are α-hydroxy ketone free radical initiators exemplified by 2-hydroxy-1-[4-(2-hydroxyethoxy)phenyl]-2-methyl-1-propanone, 2-hydroxy-2-methyl-1-phenyl-1-propanone, 1-hydroxy-cyclohexyl-phenyl-ketone, 1-hydroxy-cyclohexyl-phenyl-ketone:benzophenone, and mixtures thereof.

According to another exemplary embodiment, suitable solvents for preparation of the polymerizable solution used for producing a monovalent cation permselective layer affixed to one or both surfaces of a base cation exchange membrane, are exemplified by diethylene glycol, diethylene glycol methyl ether, 1,3-butanediol, ethanol, isopropanol, 1-butanol, N-methyl-2-pyrrolidone, dimethylacetamide, water, and mixtures thereof.

The methods disclosed herein can be used to prepare, for example, a monovalent anion permselective ion exchange membrane wherein one or both surfaces of a selected base anion exchange membrane is coated with a polymerizable solution comprising (i) a cationic monomer having one or more ethylenic groups exemplified by (meth)acryloxy groups, (meth)acrylamido groups, and vinylbenzyl groups, (ii) a hydrophobic crosslinking monomer having two or more ethylenic groups exemplified by (meth)acryloxy groups, (meth)acrylamido groups, and vinylbenzyl groups, (iii) a free radical initiator, in (iv) a solvent medium. The solution is polymerized to form a monovalent anion permselective layers affixed to the base anion exchange membrane. Suitable base anion exchange membranes are exemplified by NEOSEPTA® AMX membranes that may be sourced from Astom Corp. (Tokyo, Japan). Alternatively, suitable base anion exchange membranes may be prepared as illustrated in the Examples provided with this disclosure.

According to another exemplary embodiment, a suitable cationic monomer for preparation of a polymerizable solution for producing a monovalent anion permselective layer affixed to one or both surfaces of a base anion exchange membrane, may be a hydrophilic cationic monomer exemplified by 3-acrylamidopropyl trimethylammonium chloride, 2-acryloyloxyethyl trimethylammonium chloride, 2-methacryloyloxyethyl trimethylammonium chloride, 3-methacryloylaminopropyl trimethylammonium chloride, vinylbenzyl trimethylammonium chloride, and their mixtures.

According to another exemplary embodiment, a suitable cationic monomer for preparation of a polymerizable solution for producing a monovalent anion permselective layer affixed to one or both surfaces of a base anion exchange membrane, may be a hydrophobic cationic monomer having the structure shown in Formula 2.

According to another exemplary embodiment, a suitable cationic monomer for preparation of a polymerizable solution for producing a monovalent anion permselective layer affixed to one or both surfaces of a base anion exchange membrane, may be a cationic monomer with two or more polymerizable ethylenic groups selected from (meth)acryloxy groups, (meth)acrylamido groups, and vinylbenzyl groups. Such suitable cationic monomers may be synthesized by following the methods taught in U.S. Pat. Nos. 5,118,717 and 7,968,663.

According to another exemplary embodiment, a suitable cationic monomer for preparation of a polymerizable solution for producing a monovalent anion permselective layer affixed to one or both surfaces of a base anion exchange membrane, may be selected from a combination of two or more of cationic monomers with one or more polymerizable ethylenic groups selected from (meth)acryloxy groups, (meth)acrylamido groups, and vinylbenzyl groups.

Suitable hydrophobic cross-linking monomers for preparation of a polymerizable solution for producing a monovalent anion permselective layer affixed to one or both surfaces of a base anion exchange membrane, may be hydrophobic monomers having one or more ethylenic groups selected from (meth)acryloxy groups, (meth)acrylamido groups, and vinylbenzyl groups. Examples of crosslinking monomers include bisphenol A dimethacrylate, hexanediol diacrylate, decanediol diacrylate, hexyl diacrylamide, 4,4′-methylene bis(phenyl acrylamide), 4,4′-methylene bis(cyclohexyl acrylamide), isophorone diacrylamide, trimethyl hexamethylene diacrylamide, polyurethane oligomer diacrylate, polyester oligomer diacrylate, polyether oligomer diacrylate, epoxy oligomer diacrylate, and polybutadiene oligomer diacrylate.

Suitable free radical initiators for preparation of a polymerizable solution for producing a monovalent anion permselective layer affixed to the surface of a base anion exchange membrane, may be free radical initiators exemplified by photoinitiators that release free radicals upon exposure to UV light and include α-hydroxy ketones, benzoin ethers, benzil ketals, α-dialkoxy acetophenones, α-hydroxy alkylphenones, 60 -amino alkylphenones, acylphophine oxides, benzophenons/amines, thioxanthone/amines, and titanocenes. Suitable α-hydroxy ketone free radical initiators are exemplified by 2-hydroxy-1-[4-(2-hydroxyethoxy)phenyl]-2-methyl-1-propanone, 2-hydroxy-2-methyl-1-phenyl-1-propanone, 1-hydroxy-cyclohexyl-phenyl-ketone, 1-hydroxy-cyclohexyl-phenyl-ketone: benzophenone, and mixtures thereof.

According to another exemplary embodiment, suitable solvents for preparation of the polymerizable solution used for producing a monovalent anion permselective layer affixed to one or both surfaces of a base anion exchange membrane, are exemplified by diethylene glycol, diethylene glycol methyl ether, 1,3-butanediol, ethanol, isopropanol, 1-butanol, N-methyl-2-pyrrolidone, dimethylacetamide, water, and mixtures thereof.

The present disclosure will be further illustrated in the following examples. However it is to be understood that these examples are for illustrative purposes only, and should not be used to limit the scope of the present disclosure in any manner.

### EXAMPLES

It should be noted that in the following Examples, the permselectivity of ion exchange membranes to monovalent ions or to nitrate ions was measured following the methods taught by Xu et al. (2004, A simple determination of counter-ionic permselectivity in an ion exchange membrane from bi-ionic membrane potential measurements: permselectivity of anionic species in a novel anion exchange membrane. Sep. Purf. Technol. 40(3):231-236). The permselectivity coefficient (P_{Y}^{X}) between ion X and ion Y is indicated with their relative transport numbers while considering their solution concentrations. Commercial monovalent anion permselective ion exchange membranes (NEOSEPTA® ACS) and monovalent cation permselective ion exchange membrane (NEOSEPTA® CMS) were used as the control comparisons in each of the Examples. The permselectivity coefficient P_{SO4}^{Cl} of chloride over sulfate for the monovalent anion permselective NEOSEPTA® ACS membrane was determined to be 1.4 using the method taught by Xu et al. (2004), indicating that chloride ions are transported through this membrane 1.4 times faster than are sulfate ion under the same molar concentrations. The permselectivity coefficient P_{Ca}^{Na} of sodium over calcium for the monovalent cation permselective NEOSEPTA® CMS membrane was determined to be 3.9, indicating that sodium ions are transported through this membrane 3.9 times faster than are calcium ion under the same molar concentrations.

### Example 1

### Preparation of a Base Cation Exchange Membrane

2-acrylamido-2-methyl-1-propanesulfonic acid (10.0 g) was dissolved in dimethylacetamide (DMAc) (10.0 g). To this solution was added and mixed well, 10.7 g of 80 wt % 4,4′-methylene bis(cyclohexyl acrylamide) crosslinking monomer. Photoinitiator IRGACURE® 2959 (2.5 g) was added into the solution and mixed until dissolved (IRGACURE is a registered trademark of the Ciba-Geigy Corp., Tarrytown, N.Y., USA). The resulting solution was applied onto a woven polyester cloth (SEFAR® PET 1500; mesh open 151 μm, open area 53%, and mesh thickness 90 μm)(SEFAR is a registered trademark of Sefar Holding AG Corp., Thal, Switzerland). Excess solution was removed from the substrate by running a roller over the substrate with care being taken to exclude air bubbles from the substrate. The substrate impregnated with formula solution was irradiated with UV light (wavelength 300-400 nm) for 10 min to form the base cation exchange membrane. The properties of the resulting cation exchange membrane were determined to be:

Membrane thickness: 0.09 mm-0.10 mm

Electrical resistance: 1.0-1.4 Ωcm²

Permselectivity coefficient P_{Ca}^{Na}:0.4

### Example 2

### Preparation of a Monovalent Cation Permselective Ion Exchange Membrane

A polymerizable coating solution was prepared by mixing together (i) 2-acrylamido-2-methyl-1-propanesulfonic acid (5.0 g), (ii) 80 wt % 4,4′-methylene bis(cyclohexyl acrylamide) crosslinking monomer in a DMAc solution (71.8 g), and (iii) IRGACURE® 2959 (1.8 g). The base cation exchange membrane prepared in Example 1 was placed onto a first sheet of 3-mil polyethylene film that was placed onto a glass panel. The polymerizable coating solution was then applied onto the surface of the base membrane, after which, a second sheet of 3-mil polyethylene film was laid on top of the coating solution. Both sides of the base cation exchange membrane were coated with the polymerizing solution by running a doctor blade back and forth over top of the polyethylene/base membrane/polyethylene sandwich. The polyethylene sandwich was then irradiated with UV light (wavelength 300 nm-400 nm) for 10 min. The resulting membrane was removed from the polyethylene sandwich and then, was rinsed thoroughly in and with water. The properties of the resulting monovalent cation permselective ion exchange membrane were determined to be:

Membrane thickness: 0.11 mm-0.12 mm

Electrical resistance: 1.5-2.0 Ωcm²

Permselectivity coefficient P_{Ca}^{Na}:6.0

### Example 3

### Preparation of a Monovalent Cation Permselective Ion Exchange Membrane

A polymerizable coating solution was prepared by mixing together: (i) 75 wt % aqueous (3-acrylamidopropyl)trimethyl ammonium chloride (10.0 g), (ii) 80 wt % 4,4′-methylene bis(cyclohexyl acrylamide) crosslinker in DMAc (12.4 g), (iii) 1,3-butanediol (4.5 g), (iv) DMAc (18.0 g) and (v) IRGACURE® 2959 (0.9 g). The base cation exchange membrane prepared in Example 1 was placed onto a first sheet of 3-mil polyethylene film that was placed onto a glass panel. The polymerizable coating solution was then applied onto the surface of the base membrane, after which, a second sheet of 3-mil polyethylene film was laid on top of the coating solution. Both sides of the base cation exchange membrane were coated with the polymerizing solution by running a doctor blade back and forth over top of the polyethylene/base membrane/polyethylene sandwich. The polyethylene sandwich was then irradiated with UV light (wavelength 300 nm-400 nm) for 10 min. The resulting membrane was removed from the polyethylene sandwich and then, was rinsed thoroughly in and with water. The properties of the resulting monovalent cation permselective ion exchange membrane were determined to be:

Membrane thickness: 0.11 mm-0.12 mm

Electrical resistance: 3.0-3.5 Ωcm²

Permselectivity coefficient P_{Ca}^{Na}:2.0

### Example 4

### Preparation of a Monovalent Cation Permselective Ion Exchange Membrane

A polymerizable coating solution was prepared by mixing together: (i) 2-acrylamido-dodecane sulfonic acid (2.0 g), (ii) 80 wt % 4,4′-methylene bis(cyclohexyl acrylamide) crosslinking monomer in dimethylacetamide solution (14.2 g), and (iii) IRGACURE® 2959 (0.33 g). The base cation exchange membrane prepared in Example 1 was placed onto a first sheet of 3-mil polyethylene film that was placed onto a glass panel. The polymerizable coating solution was then applied onto the surface of the base membrane, after which, a second sheet of 3-mil polyethylene film was laid on top of the coating solution. Both sides of the base cation exchange membrane were coated with the polymerizing solution by running a doctor blade back and forth over top of the polyethylene/base membrane/polyethylene sandwich. The polyethylene sandwich was then irradiated with UV light (wavelength 300 nm-400 nm) for 10 min. The resulting membrane was removed from the polyethylene sandwich and then, was rinsed thoroughly in and with water. The properties of the resulting monovalent cation permselective ion exchange membrane were determined to be:

Membrane thickness: 0.11 mm-0.12 mm

Electrical resistance: 3.3-4.0 Ωcm²

Permselectivity coefficient P_{Ca}^{Na}:7.2

### Example 5

### Preparation of a Monovalent Cation Permselective Ion Exchange Membrane

A polymerizable coating solution was prepared by mixing together: (i) 2-acrylamido-2-methyl-1-propanesulfonic acid (2.0 g), (ii) 75 wt % aqueous (3-acrylamidopropyl)trimethyl ammonium chloride (8.0 g), (iii) 70 wt % trimethyl hexamethylene diacrylamide crosslinking monomer in DMAc solution (2.8 g), (iv) DMAc (7.2 g) and (v) IRGACURE® 2959 (0.4 g). The base cation exchange membrane prepared in Example 1 was placed onto a first sheet of 3-mil polyethylene film that was placed onto a glass panel. The polymerizable coating solution was then applied onto the surface of the base membrane, after which, a second sheet of 3-mil polyethylene film was laid on top of the coating solution. Both sides of the base cation exchange membrane were coated with the polymerizing solution by running a doctor blade back and forth over top of the polyethylene/base membrane/polyethylene sandwich. The polyethylene sandwich was then irradiated with UV light (wavelength 300 nm-400 nm) for 10 min. The resulting membrane was removed from the polyethylene sandwich and then, was rinsed thoroughly in and with water. The properties of the resulting monovalent cation permselective ion exchange membrane were determined to be:

Membrane thickness: 0.11 mm-0.12 mm

Electrical resistance: 3.5-4.0 Ωcm²

Permselectivity coefficient P_{Ca}^{Na}:10.0

### Example 6

### Preparation of a Monovalent Cation Permselective Ion Exchange Membrane

A polymerizable coating solution was prepared by mixing together: (i) 2-acrylamido-2-methyl-1-propanesulfonic acid (1.0 g), (ii) 75 wt % aqueous (3-acrylamidopropyl)trimethyl ammonium chloride (4.0 g), (iii) 70 wt % trimethyl hexamethylene diacrylamide crosslinking monomer in DMAc solution (13.3 g), (iv) DMAc (26.0 g), and (v) IRGACURE® 2959 (0.4 g) is prepared. The base cation exchange membrane prepared in Example 1 was placed onto a first sheet of 3-mil polyethylene film that was placed onto a glass panel. The polymerizable coating solution was then applied onto the surface of the base membrane, after which, a second sheet of 3-mil polyethylene film was laid on top of the coating solution. Both sides of the base cation exchange membrane were coated with the polymerizing solution by running a doctor blade back and forth over top of the polyethylene/base membrane/polyethylene sandwich. The polyethylene sandwich was then irradiated with UV light (wavelength 300 nm-400 nm) for 10 min. The resulting membrane was removed from the polyethylene sandwich and then, was rinsed thoroughly in and with water. The properties of the resulting monovalent cation permselective ion exchange membrane were determined to be:

Membrane thickness: 0.11 mm-0.12 mm

Electrical resistance: 3.7-4.2 Ωcm²

Permselectivity coefficient P_{Ca}^{Na}:6.0

### Example 7

### Preparation of a Monovalent Cation Permselective Ion Exchange Membrane

A polymerizable coating solution was prepared by mixing together: (i) 2-acrylamido-2-methyl-1-propanesulfonic acid (2.0 g), (ii) 75 wt % aqueous (3-acrylamidopropyl)trimethyl ammonium chloride (8.0 g), (iii) 70 wt % trimethyl hexamethylene diacrylamide crosslinking monomer in DMAc solution (2.8 g), (iv) DMAc (20.5 g), and (v) IRGACURE® 2959 (0.4 g) is prepared. The base cation exchange membrane prepared in Example 1 was placed onto a first sheet of 3-mil polyethylene film that was placed onto a glass panel. The polymerizable coating solution was then applied onto the surface of the base membrane, after which, a second sheet of 3-mil polyethylene film was laid on top of the coating solution. Both sides of the base cation exchange membrane were coated with the polymerizing solution by running a doctor blade back and forth over top of the polyethylene/base membrane/polyethylene sandwich. The polyethylene sandwich was then irradiated with UV light (wavelength 300 nm-400 nm) for 10 min. The resulting membrane was removed from the polyethylene sandwich and then, was rinsed thoroughly in and with water. The properties of the resulting monovalent cation permselective ion exchange membrane were determined to be:

Membrane thickness: 0.11 mm-0.12 mm

Electrical resistance: 3.0-3.5 Ωcm²

Permselectivity coefficient P_{Ca}^{Na}:4.0

### Example 8

### Preparation of a Cationic Monomer with two Ethylenic Groups

A first solution was prepared in a 250 ml flask by mixing together N-(3-dimethylamonopropyl)acrylamide (31.2 g) and DMAc (10.0 g). The solution was stirred in an ice-water bath. Acetic acid (12.0 g) was added to the solution and mixed for 1 h at room temperature. Bisphenol A diglycidyl ether (34.0 g) was dissolved in DMAc (9.3 g) and the resulting solution was slowly mixed into the first solution at room temperature after which, resulting reaction mixture was heated to and maintained at 45° C. for 3 h. The resulting cationic monomer solution was stored at a cold temperature for subsequent use for preparation of monovalent cation permselective ion exchange membranes.

### Example 9

### Preparation of a Monovalent Cation Permselective Ion Exchange Membrane

A polymerizable coating solution was prepared by mixing together: (i) the cationic monomer solution (20.0 g) from Example 8, (ii) 80 wt % of 4,4′-methylene bis(cyclohexyl acrylamide) crosslinking monomer in DMAc solution (20.0 g), and (iii) IRGACURE® 2959 (0.8 g) is prepared. The base cation exchange membrane prepared in Example 1 was placed onto a first sheet of 3-mil polyethylene film that was placed onto a glass panel. The polymerizable coating solution was then applied onto the surface of the base membrane, after which, a second sheet of 3-mil polyethylene film was laid on top of the coating solution. Both sides of the base cation exchange membrane were coated with the polymerizing solution by running a doctor blade back and forth over top of the polyethylene/base membrane/polyethylene sandwich. The polyethylene sandwich was then irradiated with UV light (wavelength 300 nm-400 nm) for 10 min. The resulting membrane was removed from the polyethylene sandwich and then, was rinsed thoroughly in and with water. The properties of the resulting monovalent cation permselective ion exchange membrane were determined to be:

Membrane thickness: 0.11 mm-0.12 mm

Electrical resistance: 4.2-5.2 Ωcm²

Permselectivity coefficient P_{Ca}^{Na}:4.5

### Example 10

### Preparation of a Base Anion Exchange Membrane

3-methacryloylaminopropyl trimethylammonium chloride (MAPTAC) (10.0 g) was dissolved in 6.5 g of 1.3-butanediol/water (90:10 wt/wt). To this solution was added and mixed, 10.7 g of 80 wt % 4,4′-methylene bis(cyclohexyl acrylamide) crosslinking monomer solution. IRGACURE® 2959 (2.5 g) was added into and dissolved in the mixture. The resulting solution was applied onto a woven polyester cloth (SEFAR® PET 1500; mesh open 151 μm, open area 53%, and mesh thickness 90 μm). Excess solution was removed from the substrate by running a roller over the substrate with care being taken to exclude air bubbles from the substrate. The substrate impregnated with formula solution was irradiated with UV light (wavelength 300-400 nm) for 10 min to form the base anion exchange membrane. The properties of the resulting anion exchange membrane were determined to be:

Membrane thickness: 0.09 mm-0.10 mm

Electrical resistance: 1.5-2.0 Ωcm²

Permselectivity coefficient P_{SO4}^{Cl}:0.5

Permselectivity coefficient P_{Cl}^{NO3}:1.0

### Example 11

### Preparation of a Monovalent Anion Permselective Ion Exchange Membrane

A coating solution comprising N,N-dimethyl-N-dodecyl-N-(3-acrylamidopropyl) ammonium bromide (7.0 g), 80 wt % 4,4′-methylene bis(cyclohexyl acrylamide) crosslinking monomer in dimethylacetamide solution (37.5 g), and IRGACURE® 2959 (0.43 g) is prepared. The base anion exchange membrane prepared in Example 10 was placed onto a first sheet of 3-mil polyethylene film that was placed onto a glass panel. The polymerizable coating solution was then applied onto the surface of the base membrane, after which, a second sheet of 3-mil polyethylene film was laid on top of the coating solution. Both sides of the base anion exchange membrane were coated with the polymerizing solution by running a doctor blade back and forth over top of the polyethylene/base membrane/polyethylene sandwich. The polyethylene sandwich was then irradiated with UV light (wavelength 300 nm-400 nm) for 10 min. The resulting membrane was removed from the polyethylene sandwich and then, was rinsed thoroughly in and with water. The properties of the resulting monovalent anion permselective ion exchange membrane were determined to be:

Membrane thickness: 0.11 mm-0.12 mm

Electrical resistance: 4.0-5.0 Ωcm²

Permselectivity coefficient P_{SO4}^{Cl}:26

Permselectivity coefficient P_{Cl}^{NO3}:6.8

### Example 12

### Preparation of Monovalent Anion Permselective Ion Exchange Membrane

A polymerizable coating solution was prepared by mixing together: (i) N,N-dimethyl-N-dodecyl-N-(3-acrylamidopropyl) ammonium bromide (7.0 g), (ii) lauryl acrylate (14 g), (iii) 80 wt % 4,4′-methylene bis(cyclohexyl acrylamide) crosslinking monomer in DMAc solution (21.0 g), and (v) IRGACURE® 2959 (0.86 g) is prepared. The base anion exchange membrane prepared in Example 10 was placed onto a first sheet of 3-mil polyethylene film that was placed onto a glass panel. The polymerizable coating solution was then applied onto the surface of the base membrane, after which, a second sheet of 3-mil polyethylene film was laid on top of the coating solution. Both sides of the base anion exchange membrane were coated with the polymerizing solution by running a doctor blade back and forth over top of the polyethylene/base membrane/polyethylene sandwich. The polyethylene sandwich was then irradiated with UV light (wavelength 300 nm-400 nm) for 10 min. The resulting membrane was removed from the polyethylene sandwich and then, was rinsed thoroughly in and with water. The properties of the resulting monovalent anion permselective ion exchange membrane were determined to be:

Membrane thickness: 0.11 mm-0.12 mm

Electrical resistance: 7.0-8.5 Ωcm²

Permselectivity coefficient P_{SO4}^{Cl}:7.4

Permselectivity coefficient P_{Cl}^{NO3}:2.3

### Example 13

### Preparation of a Monovalent Anion Permselective Ion Exchange Membrane

A polymerizable coating solution was prepared by mixing together: (i) N,N-dimethyl-N-dodecyl-N-(3-acrylamidopropyl) ammonium bromide (14.0 g), (ii) hexanediol diacrylate (30.0 g), (iii) polyurethane diacrylate (30.0g), and (iv) IRGACURE® 2959 (1.5 g) is prepared. The base anion exchange membrane prepared in Example 10 was placed onto a first sheet of 3-mil polyethylene film that was placed onto a glass panel. The polymerizable coating solution was then applied onto the surface of the base membrane, after which, a second sheet of 3-mil polyethylene film was laid on top of the coating solution. Both sides of the base anion exchange membrane were coated with the polymerizing solution by running a doctor blade back and forth over top of the polyethylene/base membrane/polyethylene sandwich. The polyethylene sandwich was then irradiated with UV light (wavelength 300 nm-400 nm) for 10 min. The resulting membrane was removed from the polyethylene sandwich and then, was rinsed thoroughly in and with water. The properties of the resulting monovalent anion permselective ion exchange membrane were determined to be:

Membrane thickness: 0.11 mm-0.12 mm

Electrical resistance: 2.5-3.0 Ωcm²

Permselectivity coefficient P_{SO4}^{Cl}:6.0

Permselectivity coefficient P_{Cl}^{NO3}:1.9

### Example 14

### Preparation of a Base Anion Exchange Membrane

A solution was prepared by mixing together 75 wt % aqueous (3-acrylamidopropyl)trimethyl ammonium (10 g), 70 wt % trimethyl hexamethylene diacrylamide crosslinking monomer in DMAc solution (20 g), diethylene glycol methyl ether (2.8g), DMAc (3.0 g), and IRGACURE® 2959 (0.7 g) is prepared. The resulting solution was applied onto a woven polyester cloth (SEFAR® PET 1500, mesh open 151 μm, open area 53%, and mesh thickness 90 μm). Excess solution was removed from the substrate by running a roller over the substrate with care being taken to exclude air bubbles from the substrate. The substrate impregnated with formula solution was irradiated with UV light (wavelength 300-400 nm) for 10 min to form the base anion exchange membrane. The properties of the resulting anion exchange membrane were determined to be:

Membrane thickness: 0.09 mm-0.10 mm

Electrical resistance: 3.5-4.0 Ωcm²

Permselectivity coefficient P_{SO4}^{Cl}:0.5

Permselectivity coefficient P_{Cl}^{NO3}:1.0

### Example 15

### Synthesis of Hydrophobic Cationic Monomer N,N-dimethyl-N-(3-alkoxy-2-hydroxylpropyl)-N-(3-acrylamidopropyl) Ammonium Acetate

Into a 250-ml flask were added 31.2 g of N-(3-dimethylamonopropyl)acrylamide and 42.4 g of isopropanol. The solution was stirred while the base of the flask was immersed in an ice-water bath. Acetic acid (12.0 g) was then added into the solution and the resulting reaction was maintained at ambient room temperature for one hour. Then, 56.2 g of C₁₂-C₁₄ alkyl glycidyl ether (Dow Chemical Company, equivalent weight 280) were added slowly into the solution at room temperature, after which, the reaction mixture was heated and kept at 45° C. for 3 h. The resulting hydrophobic cationic monomer solution was stored at a cold temperature until required for use in preparation of monovalent anion permselective ion exchange membranes.

### Example 16

### Preparation of a Monovalent Anion Permselective Ion Exchange Membrane

A polymerizable coating solution was prepared by mixing together: (i) the hydrophobic cationic monomer N,N-dimethyl-N-(3-alkoxy-2-hydroxylpropyl)-N-(3-acrylamidopropyl) ammonium acetate (7.0 g) prepared in Example 15, (ii) 70 wt % trimethyl hexamethylene diacrylamide crosslinking monomer (16.3 g), and (iii) IRGACURE® 2959 (0.47 g). The base anion exchange membrane prepared in Example 14 was placed onto a first sheet of 3-mil polyethylene film that was placed onto a glass panel. The polymerizable coating solution was then applied onto the surface of the base membrane, after which, a second sheet of 3-mil polyethylene film was laid on top of the coating solution. Both sides of the base anion exchange membrane were coated with the polymerizing solution by running a doctor blade back and forth over top of the polyethylene/base membrane/polyethylene sandwich. The polyethylene sandwich was then irradiated with UV light (wavelength 300 nm-400 nm) for 10 min. The resulting membrane was removed from the polyethylene sandwich and then, was rinsed thoroughly in and with water. The properties of the resulting monovalent anion permselective ion exchange membrane were determined to be:

Membrane thickness: 0.11 mm-0.12 mm

Electrical resistance: 7.0-7.5 Ωcm²

Permselectivity coefficient P_{SO4}^{Cl}:60

Permselectivity coefficient P_{Cl}^{NO3}:20

### Example 17

### Preparation of a Monovalent Anion Permselective Ion Exchange Membrane

A polymerizable coating solution was prepared by mixing together: (i) the hydrophobic cationic monomer N,N-dimethyl-N-(3-alkoxy-2-hydroxylpropyl)-N-(3-acrylamidopropyl) ammonium acetate (5.0 g) prepared in Example 15, (ii) 75 wt % aqueous (3-acrylamidopropyl)trimethyl ammonium (0.6 g), 70 wt % trimethyl hexamethylene diacrylamide crosslinking monomer (22.8 g), and (iii) IRGACURE® 2959 (0.57 g). The base anion exchange membrane prepared in Example 14 was placed onto a first sheet of 3-mil polyethylene film that was placed onto a glass panel. The polymerizable coating solution was then applied onto the surface of the base membrane, after which, a second sheet of 3-mil polyethylene film was laid on top of the coating solution. Both sides of the base anion exchange membrane were coated with the polymerizing solution by running a doctor blade back and forth over top of the polyethylene/base membrane/polyethylene sandwich. The polyethylene sandwich was then irradiated with UV light (wavelength 300 nm-400 nm) for 10 min. The resulting membrane was removed from the polyethylene sandwich and then, was rinsed thoroughly in and with water. The properties of the resulting monovalent anion permselective ion exchange membrane were determined to be:

Membrane thickness: 0.11 mm-0.12 mm

Electrical resistance: 5.5-6.5 Ωcm²

Permselectivity coefficient P_{SO4}^{Cl}:32

Permselectivity coefficient P_{Cl}^{NO3}:9

1. A monovalent ion permselective ion exchange membrane, comprising:
a base layer consisting of an ion exchange membrane having two opposing surfaces; and
a monovalent ion permselective layer affixed onto one surface or onto both surfaces of the base layer, said monovalent ion permselective layer formed by coating and polymerizing a polymerizable solution onto the one surface or onto both surfaces of the base layer, said polymerizable solution comprising (i) an ionic monomer having one or more ethylenic groups selected from (meth)acryloxy groups, (meth)acrylamido groups, and vinylbenzyl groups, (ii) a hydrophobic crosslinking monomer having two or more ethylenic groups selected from (meth)acryloxy groups, (meth)acrylamido groups, and vinylbenzyl groups, (iii) a free radical initiator, in (iv) a solvent medium.

2. A monovalent ion permselective ion exchange membrane according to claim 1, wherein the monovalent ion permselective layer is affixed to one surface or to both surfaces of the base ion exchange membrane by covalent bonding through the copolymerization between ethylenic groups in the base layer and ethylenic groups of monomers in the surface coating solution.

3. A monovalent ion permselective ion exchange membrane according to claim 1, wherein the monovalent ion permselective layer is affixed to one surface or to both surfaces of the base ion exchange membrane by interpenetration of polymer chains from the permselective layer with polymer chains from the base layer of ion exchange membrane.

4. A monovalent ion permselective ion exchange membrane according to claim 1, wherein the monovalent ion permselective layer is affixed to one surface or to both surfaces of the base ion exchange membrane by mechanical interlocking of polymer chains from the permselective layer within the microroughness of the base ion exchange membrane.

5. A monovalent ion permselective ion exchange membrane according to claim 1, wherein the monovalent ion permselective ion exchange membrane is a monovalent cation permselective ion exchange membrane, and the base layer is a cation exchange membrane.

6. A monovalent cation permselective ion exchange membrane according to claim 5, wherein the ionic monomer is iophobia an anionic monomer having a chemical structure shown in Formula 1, 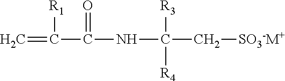
wherein R₁ is a hydrogen or a methyl group, R₃ is a hydrogen or a C₁-C₃ alkyl group, R₄ is a a C₄-C₂₂ alkyl group, and M⁺ is a H⁺ ion or a salt ion.

7. A monovalent cation permselective ion exchange membrane according to claim 5, wherein the ionic monomer is a cationic monomer having a chemical structure shown in Formula 2, 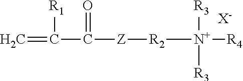
wherein R₁ is a hydrogen or a methyl group, Z is —O— or —NH—, R₂ and is a C₁-C₄ alkylene group, R₃ is a C₁-C₄ alkyl group, R₄ is a C₆-C₂₂ alkyl group, a C₆-C₂₂ hydroxyalkyl group, or a C₆-C₂₂ 3-alkoxy-2-hydroxypropyl group, and X⁻ is Cl³¹, Br⁻, I⁻, or acetate.

8. A monovalent cation permselective ion exchange membrane according to claim 5, wherein the ionic monomer is one of 3-sulfopropyl acrylate potassium salt, and 2-acrylamido-2-methyl-1-propanesulfonic acid.

9. A monovalent cation permselective ion exchange membrane according to claim 5, wherein the ionic monomer is an anionic monomer having two or more ethylenic groups selected from (meth)acryloxy groups, (meth)acrylamido groups, and vinylbenzyl groups.

10. A monovalent cation permselective ion exchange membrane according to claim 5, wherein the ionic monomer is one of 3-acrylamidopropyl trimethylammonium chloride, 2-acryloyloxyethyl trimethylammonium chloride, 2-methacryloyloxyethyl trimethylammonium chloride, 3-methacryloylaminopropyl trimethylammonium chloride, vinylbenzyl trimethylammonium chloride, and their mixtures.

11. A monovalent cation permselective ion exchange membrane according to claim 5, wherein the ionic monomer is a mixture consisting of an anionic monomer and a cationic monomer wherein the molar ratio of the anionic monomer to the cationic monomer is in the range of about 0.05:1 to about 0.95:1.

12. A monovalent cation permselective ion exchange membrane according to claim 5, wherein the hydrophobic crosslinking monomer is one of bisphenol A dimethacrylate, hexanediol diacrylate, decanediol diacrylate, hexyl diacrylamide, 4,4′-methylene bis(phenyl acrylamide), 4,4′-methylene bis(cyclohexyl acrylamide), isophorone diacrylamide, trimethyl hexamethylene diacrylamide, polyurethane oligomer diacrylate, polyester oligomer diacrylate, polyether oligomer diacrylate, epoxy oligomer diacrylate, and polybutadiene oligomer diacrylate.

13. A monovalent ion permselective ion exchange membrane according to any claim 1 wherein the monovalent ion permselective ion exchange membrane is a monovalent anion permselective ion exchange membrane, and the base layer is an anion exchange membrane.

14. A monovalent anion permselective ion exchange membrane according to claim 13, wherein the ionic monomer is one of 3-acrylamidopropyl trimethylammonium chloride, 2-acryloyloxyethyl trimethylammonium chloride, 2-methacryloyloxyethyl trimethylammonium chloride, 3-methacryloylaminopropyl trimethylammonium chloride, vinylbenzyl trimethylammonium chloride, and mixtures thereof.

15. A monovalent anion permselective ion exchange membrane according to claim 13, wherein the ionic monomer is a cationic monomer having a chemical structure shown in Formula 2. 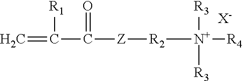
wherein R₁ is a hydrogen or a methyl group, Z is —O— or —NH—, R₂ is a C₁-C₄ alkylene group, R₃ is a C₁-C₄ alkyl group, R₄ is one of a C₆-C₂₂ alkyl group, a C₆-C₂₂ hydroxyalkyl group, or a C₆-C₂₂ 3-alkoxy-2-hydroxypropyl group, and X⁻ is Cl⁻, Br⁻, I⁻, or acetate.

16. A monovalent anion permselective ion exchange membrane according to claim 13, wherein the hydrophobic crosslinking monomer is one of bisphenol A dimethacrylate, hexanediol diacrylate, decanediol diacrylate, hexyl diacrylamide, 4,4′-methylene bis(phenyl acrylamide), 4,4′-methylene bis(cyclohexyl acrylamide), isophorone diacrylamide, trimethyl hexamethylene diacrylamide, polyurethane oligomer diacrylate, polyester oligomer diacrylate, polyether oligomer diacrylate, epoxy oligomer diacrylate, and polybutadiene oligomer diacrylate.

17. A process for preparing a monovalent cation permselective ion exchange membrane, comprising the steps of:
selecting a base cation exchange membrane having two opposing surfaces;
preparing a polymerizable solution comprising a mixture of (i) an ionic monomer having one or more ethylenic groups selected from (meth)acryloxy groups, (meth)acrylamido groups, and vinylbenzyl groups, (ii) a hydrophobic crosslinking monomer having two or more ethylenic groups selected from (meth)acryloxy groups, (meth)acrylamido groups, and vinylbenzyl groups, (iii) a free radical initiator, in (iv) a solvent medium;
coating the polymerizable solution onto one surface or onto both surfaces of the base cation exchange membrane; and
polymerizing the polymerizable solution to form a monovalent cation permselective layer affixed to the one surface or to both surfaces of the base cation exchange membrane.

18. A process according to claim 17, wherein the ionic monomer is an anionic monomer having a chemical structure shown in Formula 1, 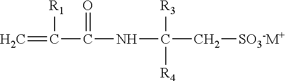
wherein R₁ is a hydrogen or a methyl group, R₃ is a hydrogen or a C₁-C₃ alkyl group, R4 is a C₄-C₂₂ alky group, and M⁺ is a H⁺ ion or a salt ion.

19. A process according to claim 17, wherein the ionic monomer is one of 3-sulfopropyl acrylate potassium salt, and 2-acrylamido-2-methyl-1-propanesulfonic acid.

20. A process according to claim 17, wherein the ionic monomer is an anionic monomer having two or more ethylenic groups selected from (meth)acryloxy groups, (meth)acrylamido groups, and vinylbenzyl groups.

21. A process according to claim 17, wherein the ionic monomer is one of 3-acrylamidopropyl trimethylammonium chloride, 2-acryloyloxyethyl trimethylammonium chloride, 2-methacryloyloxyethyl trimethylammonium chloride, 3-methacryloylaminopropyl trimethylammonium chloride, vinylbenzyl trimethylammonium chloride, and their mixtures.

22. A process according to claim 17, wherein the ionic monomer a mixture consisting of an anionic monomer and a cationic monomer wherein the molar ratio of the anionic monomer to the cationic monomer is in the range of about 0.05:1 to about 0.95:1.

23. A process according to claim 17, wherein the hydrophobic crosslinking monomer is one of bisphenol A dimethacrylate, hexanediol diacrylate, decanediol diacrylate, hexyl diacrylamide, 4,4′-methylene bis(phenyl acrylamide), 4,4′-methylene bis(cyclohexyl acrylamide), isophorone diacrylamide, trimethyl hexamethylene diacrylamide, polyurethane oligomer diacrylate, polyester oligomer diacrylate, polyether oligomer diacrylate, epoxy oligomer diacrylate, and polybutadiene oligomer diacrylate.

24. A process for preparing a monovalent anion permselective ion exchange membrane, comprising the steps of
selecting a base anion exchange membrane having two opposing surfaces;
preparing a polymerizable solution comprising a mixture of: (i) a cationic monomer having one or more ethylenic groups selected from (meth)acryloxy groups, (meth)acrylamido groups, and vinylbenzyl groups, (ii) a hydrophobic crosslinking monomer having two or more ethylenic groups selected from (meth)acryloxy groups, (meth)acrylamido groups, and vinylbenzyl groups, (iii) a free radical initiator, in (iv) a solvent medium;
coating the polymerizable solution onto one surface or onto both surfaces of the base anion exchange membrane; and
polymerizing the polymerizable solution to form a monovalent anion permselective layer affixed to the one surface or to both surfaces of the base anion exchange membrane.

25. A process according to claim 24, wherein the cationic monomer is one of 3-acrylamidopropyl trimethylammonium chloride, 2-acryloyloxyethyl trimethylammonium chloride, 2-methacryloyloxyethyl trimethylammonium chloride, 3-methacryloylaminopropyl trimethylammonium chloride, vinylbenzyl trimethylammonium chloride, and mixtures thereof.

26. A process according to claim 24, wherein the cationic monomer is a cationic monomer having a chemical structure shown in Formula 2, 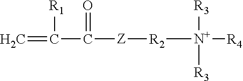
wherein R₁ is a hydrogen or a methyl group, Z is —O— or —NH—, R₂ is a C₁-C₄ alkylene group, R₃ is a C₁-C₄ alkyl group, R₄ is a C₆-C₂₂ alkyl group, a C₆-C₂₂ hydroxyalkyl group, or a C₆-C₂₂ 3-alkoxy-2-hydroxypropyl group, and X⁻ is Cl⁻, Br⁻, I⁻, or acetate.

27. A process according to claim 24, wherein the hydrophobic crosslinking monomer is one of bisphenol A dimethacrylate, hexanediol diacrylate, decanediol diacrylate, hexyl diacrylamide, 4,4′-methylene bis(phenyl acrylamide), 4,4′-methylene bis(cyclohexyl acrylamide), isophorone diacrylamide, trimethyl hexamethylene diacrylamide, polyurethane oligomer diacrylate, polyester oligomer diacrylate, polyether oligomer diacrylate, epoxy oligomer diacrylate, and polybutadiene oligomer diacrylate.

28. A process for preparing a monovalent ion permselective ion exchange membrane, comprising the steps of:
preparing a first solution for base ion exchange membrane;
preparing a second polymerizable solution for monovalent ion permselective layer, said second solution comprising a mixture of: (i) an ionic monomer having one or more ethylenic groups selected from (meth)acryloxy groups, (meth)acrylamido groups, and vinylbenzyl groups, (ii) a hydrophobic crosslinking monomer having two or more ethylenic groups selected from (meth)acryloxy groups, (meth)acrylamido groups, and vinylbenzyl groups, (iii) a free radical initiator, in (iv) a solvent medium;
casting the first solution to form a base layer for the ion exchange membrane:
coating the second solution onto at least one surface of the base layer; and
curing the coated base layer to form a monovalent ion permselective layer affixed to at least one surface of the base ion exchange membrane.

29. (canceled)
